(19) United States
(12) Patent Application Publication
(10) Pub. No.: US 2009/0285441 A1
(43) Pub. Date: Nov. 19, 2009

(54) Loudspeaker Having a Continuous Molded Diaphragm

(75) Inventor: Bruce W. Howze, Broomall, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: COMMUNITY LIGHT & SOUND, INC., Chester, PA (US)

(21) Appl. No.: 12/121,162

(22) Filed: May 15, 2008

(51) Int. Cl. H04R 1/00

(52) U.S. Cl. 381/423

(57) ABSTRACT

A loudspeaker is disclosed. The loudspeaker includes a rigid frame, a diaphragm is firmly attached to the frame. A plurality of transducers attached to the diaphragm. In use, the loudspeaker radiates acoustic energy by pistonic motion of the diaphragm in response to actuation by the plurality of transducers. The motion of the diaphragm is in a substantially fundamental mode.

### BACKGROUND OF THE INVENTION

1. Field of the Invention

The present invention relates to a loudspeaker and more particularly to a loudspeaker having continuous molded diaphragm driven by multiple transducers.

2. Background

In the field of public address systems it is especially important for the public address system to have control over the radiation pattern of the acoustic energy output in order that energy of the proper magnitude is distributed to all desired portions of the public space, that reflections be minimized and that unintended nulls not be produced.

The most common method of providing a controlled acoustic radiation pattern is by the use of specifically designed horn loudspeakers such as those described in U.S. Pat. Nos. 4,187,926 and 4,071,112. Such horns are large in size and require the use of relatively expensive compression drivers.

Another known method of providing a controlled acoustic radiation pattern, as described by U.S. Pat. No. 6,834,113, is the use of multiple direct radiator loudspeakers arranged in an array. The method can provide a uniform radiation pattern at low and midrange frequencies, but when the wavelength of the radiation is comparable to the physical separation of the radiators, the radiation pattern splits into lobes, thus producing undesired nulls in the far field of the radiation pattern.

What is required but is not provided by the prior art is a loudspeaker system for mid range and high frequency audio signals using multiple drivers which can be arranged as an array of arbitrary shape such that a particularized acoustic radiation pattern can be produced over the desired frequency range and which does not suffer from undesired nulls in the far field of the radiation pattern.

### BRIEF SUMMARY OF THE INVENTION

A loudspeaker is disclosed. The loudspeaker includes a rigid frame; a diaphragm firmly attached to the frame; and a plurality of transducers attached to the diaphragm. In use, the loudspeaker radiates acoustic energy by pistonic motion of the diaphragm in response to actuation by the plurality of transducers, the motion of the diaphragm being in a substantially fundamental mode.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1A is a plan view of a loudspeaker including a continuous strip diaphragm according to a first preferred embodiment;

FIG. 1B is a cross-section of the loudspeaker shown in FIG. 1;

FIGS. 2A-2F show the radiation pattern of the first preferred embodiment in a plane perpendicular to the longer dimension;

FIGS. 3A-3F show the radiation pattern of the first preferred embodiment in a plane parallel to the longer diameter dimension;

FIG. 4 shows a cross sectional view of a molded continuous strip diaphragm in a uniformly curved frame in accordance with a second preferred embodiment;

FIG. 5 shows a cross sectional view of a molded continuous strip diaphragm in a non-uniformly curved frame in accordance with a third preferred embodiment;

FIG. 6 shows a top cross sectional view, a side cross sectional view and a plan view of a molded continuous planar diaphragm in a frame that is straight in one dimension and uniformly curved in the other direction in accordance with a fourth preferred embodiment;

FIG. 7 shows a top cross sectional view, a side cross sectional view and a plan view of a molded continuous diaphragm in a bi-directionally curved frame in accordance with a fifth preferred embodiment. The radiation pattern will approximate the angle of curvature in each dimension;

FIG. 8 shows side and bottom views of a molded continuous diaphragm in an angled ring frame in accordance with a sixth preferred embodiment; and

FIG. 9 shows a side view of molded continuous spherical section diaphragm assembly in accordance with a seventh preferred embodiment.

### DETAILED DESCRIPTION OF THE INVENTION

Certain terminology is used in the following description for convenience only and is not limiting. The words “right,” “left,” “lower”, “upper”, “horizontal” and “vertical” designate directions in the drawings to which reference is made. The words “inwardly” and “outwardly” refer to directions toward and away from, respectively, the geometric center of a loudspeaker in accordance with the present invention, and designated parts thereof. The terminology includes the words noted above, derivatives thereof and words of similar import.

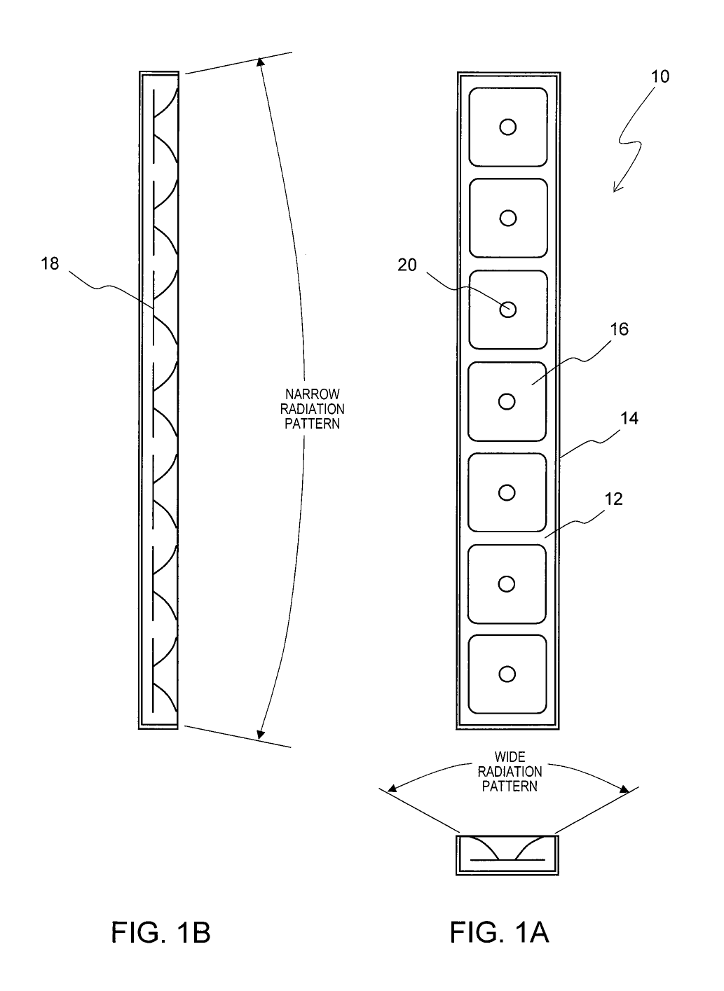

Referring now to FIGS. 1A and 1B there is shown a loudspeaker 10 in accordance with a first preferred embodiment. The loudspeaker 10 includes a rigid frame 14, and a diaphragm 12 having a plurality of cone-like indentations 16 attached to the frame 14. An electromechanical transducer 18 is attached to a frustum 20 of each one of the plurality of indentations 18.

Preferably the frame 14 forms an enclosure having an opening, with the diaphragm 12 attached to the edges of the opening and closing the opening. In the first preferred embodiment, the enclosure is box-like. However the enclosure may be of any shape having sufficient dimensions to contain the diaphragm 12 and the transducers 18. Further, the frame 14 need not be an enclosure but may be an open frame. In the preferred embodiment, the frame 14 is made of a rigid polymeric material. However, other rigid materials including but not limited to metal, wood, and composite materials could also be used for the frame 14.

The diaphragm 12 is a molded continuous strip of a polyester material, commonly referred to as Mylar®, having a nominal thickness of 0.004 inches. However, the diaphragm 12 need not be made of Mylar. Other materials which lend themselves to being molded may be used, including but not limited to paper, carbon fiber, polypropylene and metal. In the first preferred embodiment, the diaphragm 12 is firmly attached at its edges to the frame 14 by an adhesive such that there is no substantial movement of the adhered portion of the diaphragm 12 with respect to the frame when the loudspeaker 10 is in use. While it is preferred to attach the diaphragm 12 to the frame 14 with an adhesive, the diaphragm 12 could also be attached to the frame 14 by fasteners such as screws, nails or staples.

Preferably, the diaphragm 12 includes a plurality of cone-like indentations 16. Such indentations 16 are for the purpose of providing a degree of rigidity to the diaphragm 12 such that when the diaphragm 12 is actuated by the plurality of transducers 18 being excited in-phase by an electrical signal, the diaphragm 12 as a continuous surface radiates acoustic energy by pistonic motion of the diaphragm 12 (i.e. the diaphragm moving as a rigid whole) with the diaphragm 12 vibrating in a substantially fundamental mode. As a result of the diaphragm 12 moving as a rigid whole, the effective aperture of the loudspeaker 10 and thus the shape of the acoustic pattern, is controlled by the dimensions of the diaphragm 12.

In the first preferred embodiment, a transducer 18 is rigidly attached to the frustum 20 of each indentation 16 by an adhesive to actuate the diaphragm 12 at frequencies within the audible range. Preferably, the adhesive is a quick setting epoxy adhesive but other adhesives could be used.

Preferably, the transducers 18 are piezoelectric transducers of well known design which are attached to the frustum 20 of each indentation 16. However, the transducers 18 need not be piezoelectric transducers but could be conventional voice coil and magnet transducers. In the latter case, the magnet portion of the transducer would be attached to the frame 14 of the loudspeaker. In use, the transducers 18 are driven by an electrical signal such the mechanical motion of the transducers 18 are in phase with each other.

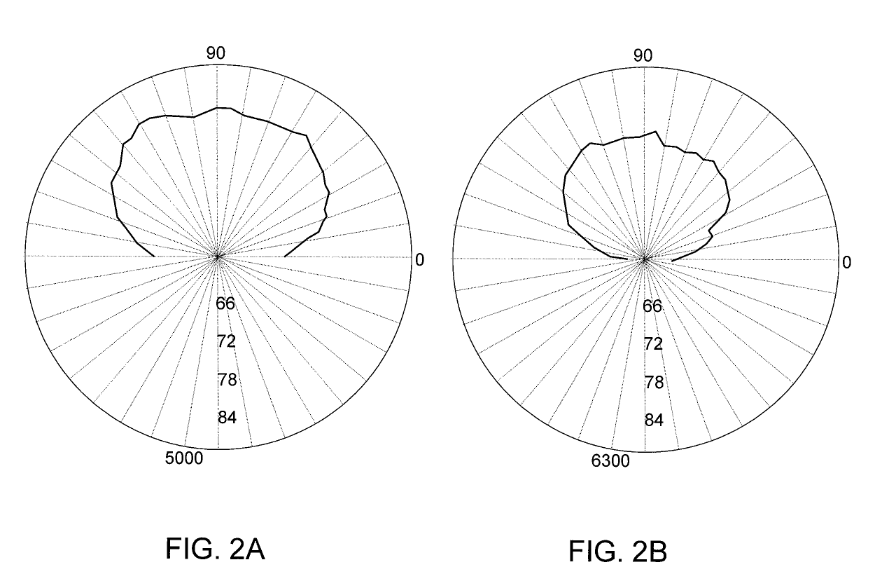

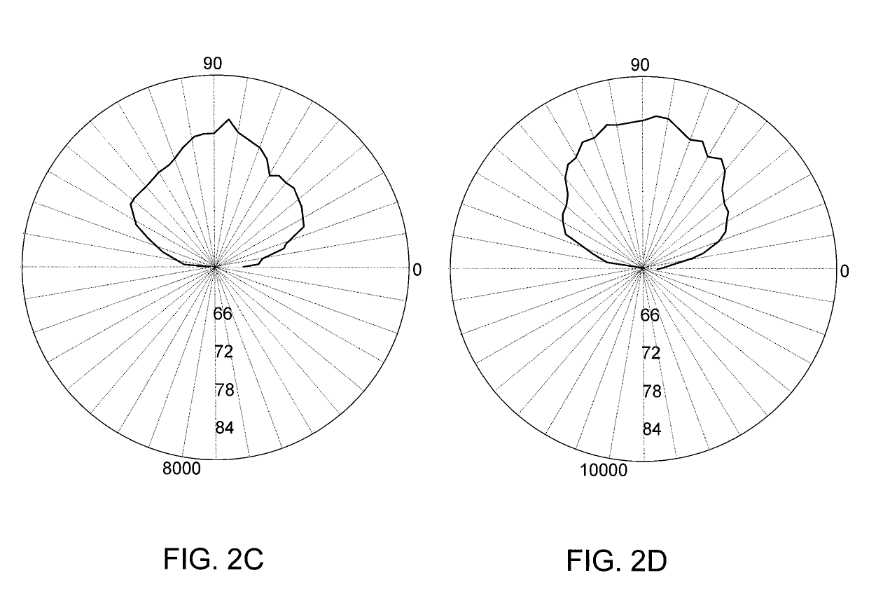

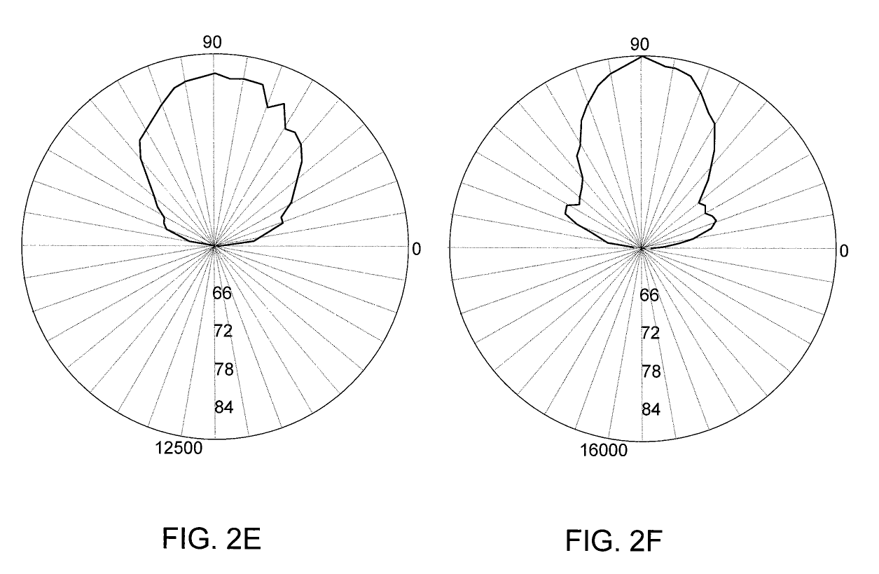

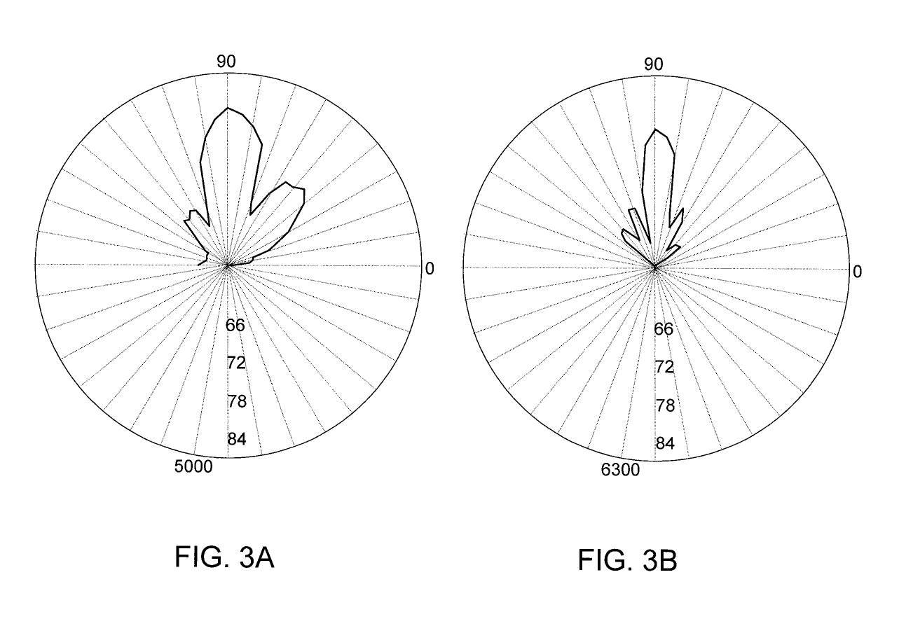

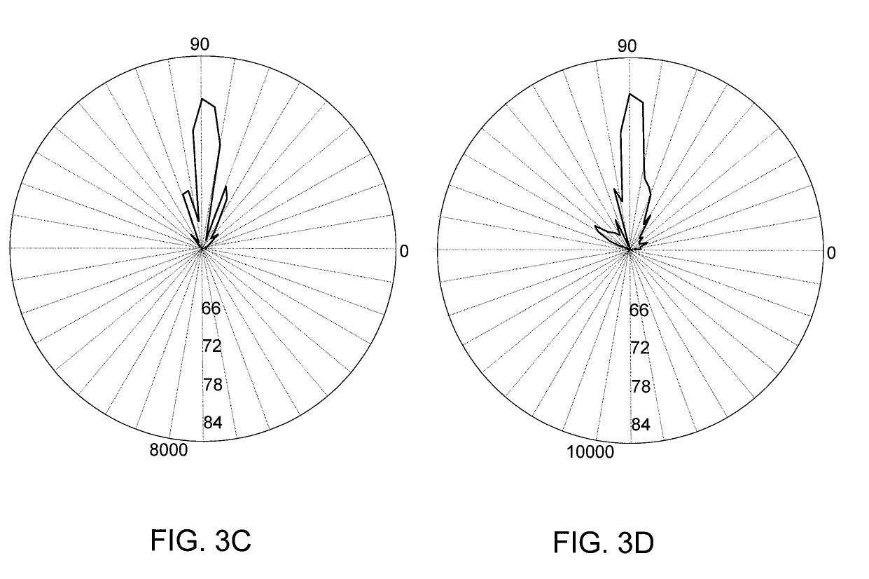

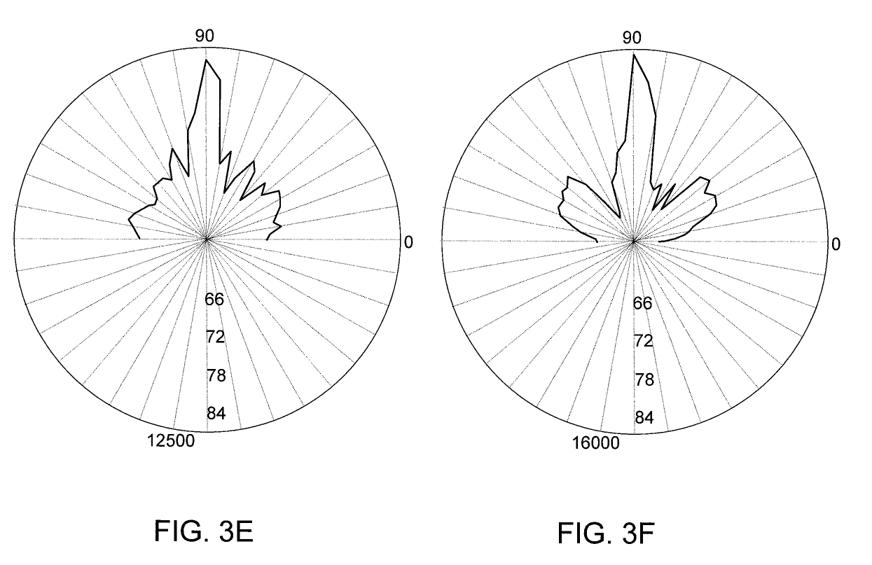

The first preferred embodiment of the loudspeaker 10 comprises a rectangularly shaped diaphragm 12 having a linear array of seven indentations 16 in a single row as shown in FIGS. 1A and 1B. As shown in FIGS. 2A-2F and 3A-3F, the radiation pattern of the loudspeaker 10 is wide across the short dimension of the diaphragm 12 and is narrow across the long dimension of the loudspeaker 10.

The first preferred embodiment of the loudspeaker 10 is housed in a box-like structure approximately 1 in. width by 7 in. in length by ½ in. in depth, with each indentation 16 having a width at the base of approximately 1 in. and having a depth to the frustum 20 of approximately ¼ in. Such a loudspeaker 10 is suitable for operation in the range of approximately 5000 to 16000 Hz. However, the loudspeaker 10 is not limited to the range of 5000-16000 Hz. The loudspeaker 10 is suitable for operation at higher and at lower frequencies by adjusting the size of the diaphragm 12 and the corresponding indentations 16 in inverse relation to the desired frequency range. FIGS. 2A-2F show the 360 degree far field acoustic radiation pattern in a plane perpendicular to the longer dimension of the loudspeaker at 5000, 6300, 8000, 10000, 12500 and 16000 Hz respectively, the scale of intensity being in decibels. FIGS. 3A-3F show the 360 degree radiation pattern of the loudspeaker in a plane parallel to the longer length of the loudspeaker at 5000, 6300, 8000, 10000, 12500 and 16000 Hz respectively. Note the narrow width of the pattern and lack of excessive multi-lobing in FIGS. 3A-3F, suggesting that the diaphragm moves pistonically in a substantially fundamental mode.

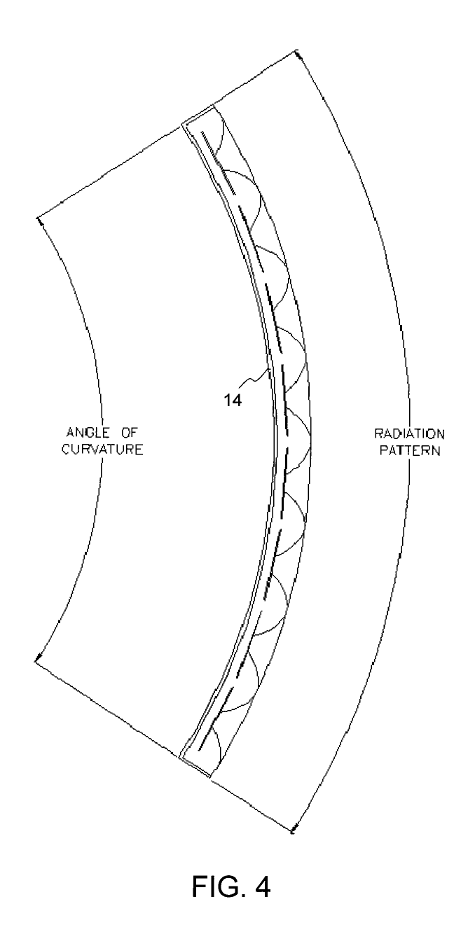

FIG. 4 shows a molded continuous strip diaphragm 12a in a uniformly curved frame in accordance with a second preferred embodiment. The radiation pattern across the long dimension of the diaphragm 12a will approximate the angle of curvature. The intensity of radiation will be substantially uniform within the pattern.

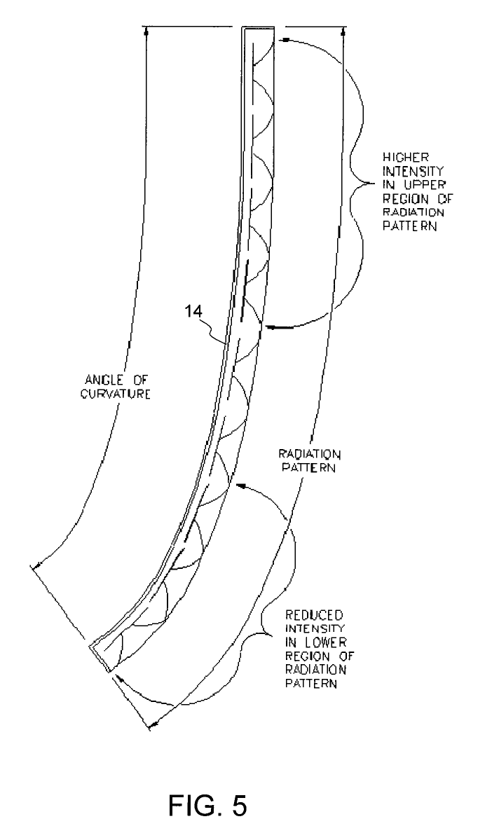

FIG. 5 shows a molded continuous strip diaphragm 12b in a non-uniformly curved frame in accordance with a third preferred embodiment. The curvature of the frame is slight in the upper portion of the frame and the curvature progressively increases toward the lower portion of the frame. The radiation pattern across the long dimension will approximate the angle of curvature, but the intensity of the radiation pattern will be higher in the upper region of the pattern and reduced in the lower region of the pattern.

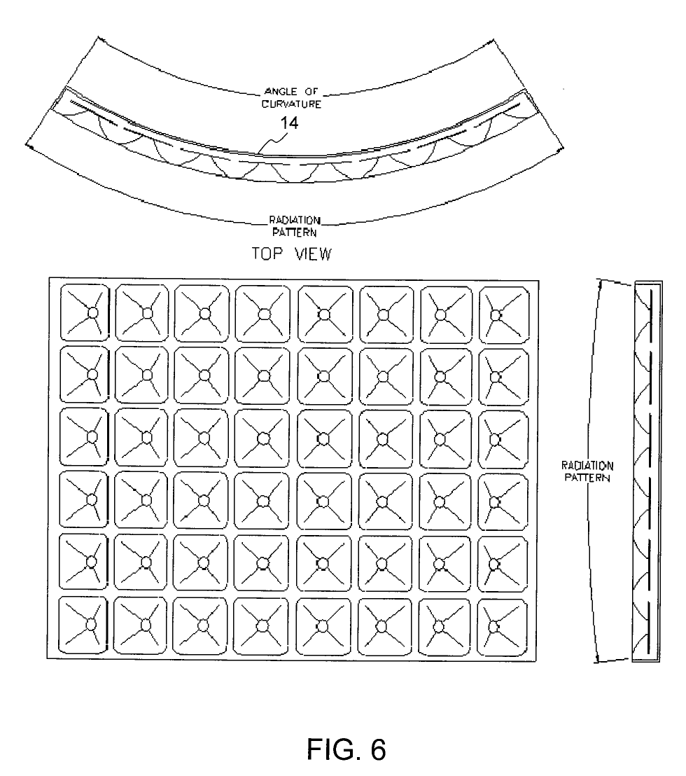

FIG. 6 shows a molded continuous planar diaphragm 12c in a frame that is straight in one dimension and uniformly curved in the other direction in accordance with a fourth preferred embodiment. The radiation pattern will be narrow across the straight dimension and will approximate the angle of curvature across the curved dimension. If the radius of curvature is uniform across the curved dimension, the intensity of the radiation will be uniform across the pattern. If the radius of curvature is not uniform, the intensity of the radiation will vary directly with the radius of curvature.

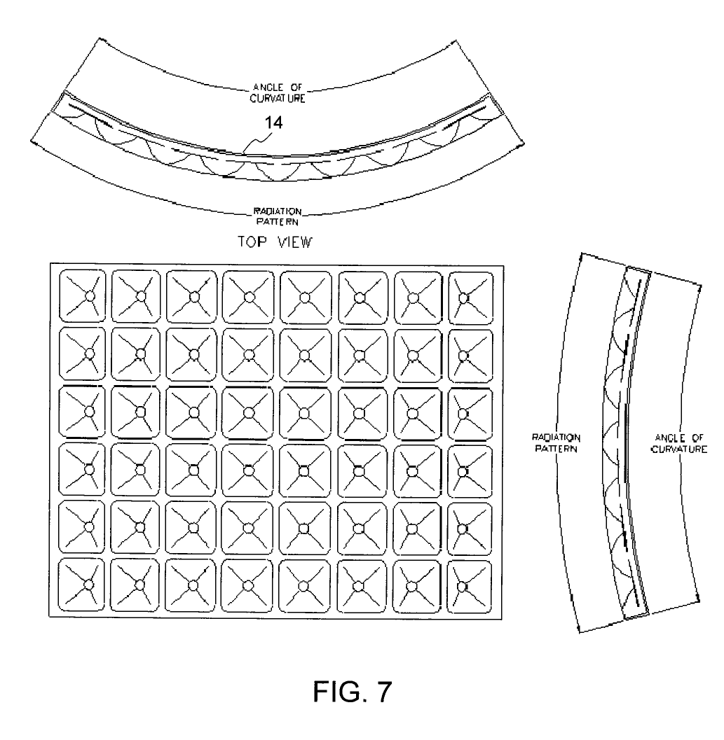

FIG. 7 shows a molded continuous diaphragm 12d in a bi-directionally curved frame in accordance with a fifth preferred embodiment. The radiation pattern will approximate the angle of curvature in each dimension. If the radius of curvature is uniform, the intensity of the radiation will be uniform across the pattern. If the radius of curvature is not uniform, the intensity of the radiation will vary directly with the radius of curvature.

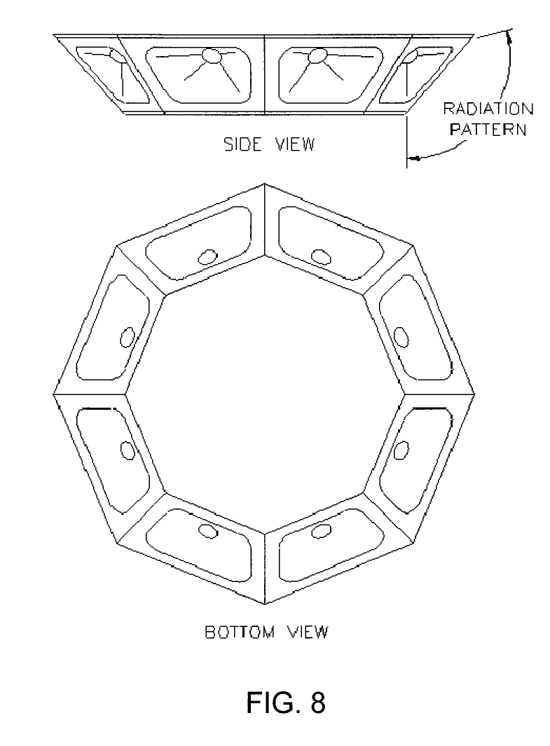

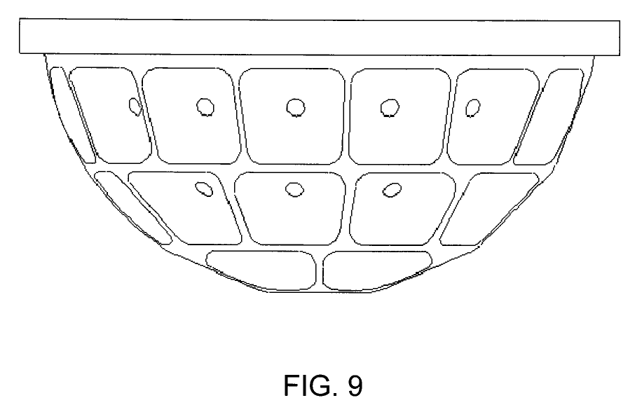

FIG. 8 shows a molded continuous diaphragm 12e in an angled ring frame in accordance with a sixth preferred embodiment. The radiation pattern will be 360° around the ring. If the radius of the ring is uniform, the intensity of the radiation will be substantially uniform around the ring. If the radius of curvature is not uniform, the intensity of radiation will vary directly with the radius of curvature.

FIG. 9 shows a molded continuous spherical section diaphragm 12f in a frame in accordance with a sixth preferred embodiment. The radiation pattern will approximate the shape of the spherical section. If the radius of curvature is uniform, the intensity of the radiation will be uniform. If the radius of curvature is not uniform, the intensity of the radiation will vary directly with the radius of curvature.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. A loudspeaker comprising:
a rigid frame;
a diaphragm firmly attached to the frame;
a plurality of transducers attached to the diaphragm, wherein in use, the loudspeaker radiates acoustic energy by pistonic motion of the diaphragm in response to actuation by the plurality of transducers, the motion of the diaphragm being in a substantially fundamental mode.

2. The loudspeaker according to claim 1, wherein the diaphragm is made of a molded polymeric material.

3. The loudspeaker according to claim 1, wherein the diaphragm includes a plurality of cone-like indentations.

4. The loudspeaker according to claim 3, wherein each one of the plurality of transducers is attached to a frustum of one of the indentations.

5. The loudspeaker of claim 1, wherein each of one of the transducers is a piezoelectric transducer.

6. The loudspeaker of claim 1, wherein each one of the transducers is a voice coil/magnet combination.

7. The loudspeaker of claim 1, wherein the frame is an enclosure, the diaphragm closing the enclosure.

8. The loudspeaker of claim 1, wherein the frame is curved in at least one dimension such that the diaphragm when attached to the frame forms a generally convex shape, thereby forming a dispersed radiation pattern.

9. The loudspeaker of claim 1, wherein the dimension of the diaphragm is larger in the vertical direction than in the horizontal direction such that the acoustic beam width is larger in the horizontal direction than in the vertical direction.

10. The loudspeaker of claim 1, wherein actuation of the diaphragm by each one of the transducers is substantially in-phase.
